(19) United States
(12) Patent Application Publication
(10) Pub. No.: US 2026/0316517 A1
(43) Pub. Date: Oct. 15, 2026

(54) HEAT PUMP SYSTEM FOR AN ELECTRICALLY OPERATED VEHICLE

(71) Applicant: HELLA GmbH & Co. KGaA, Lippstadt (DE)

(72) Inventor: Sebastian TIEMEYER, Dortmund (DE)

(73) Assignee: HELLA GmbH & Co. KGaA, Lippstadt (DE)

(21) Appl. No.: 19/689,704

(22) Filed: May 27, 2026

Related U.S. Application Data
(63) Continuation of application No. PCT/EP2024/082234, filed on Nov. 13, 2024.

(30) Foreign Application Priority Data
Nov. 28, 2023 (DE) 10 2023 133 133.7

(51) Int. Cl. B60H 1/00

(52) U.S. Cl. CPC B60H 1/00392; B60H 1/00328; B60H 1/00342; B60H 1/00899; B60H 1/00278

(57) ABSTRACT

A heat pump system comprising a coolant side and a refrigerant side. The coolant side has a first flow section with a first heat exchanger, a second flow section with a second heat exchanger, a bypass flow section for bypassing the second heat exchanger in terms of flow, a third flow section with a third heat exchanger, a fourth flow section, a coolant pump system and a valve system. In a first operating state, a coolant flow flows through the first flow section with the first heat exchanger, then through the bypass flow section and/or through the second flow section with the second heat exchanger, and then through the fourth flow section. In a second operating state, a coolant flow flows through the first flow section, then through the bypass flow section and/or through the second flow section and then through the third flow section with the third heat exchanger.

This nonprovisional application is a continuation of International Application No. PCT/EP 2024/082234, which was filed on Nov. 13, 2024, and which claims priority to German Patent Application No. 10 2023 133 133.7, which was filed in Germany on Nov. 28, 2023, and which are both herein incorporated by reference.

### BACKGROUND OF THE INVENTION

### Field of the Invention

The present invention relates to a heat pump system for an electrically operated vehicle.

### Description of the Background Art

Heat pump systems for electrically operated vehicles are known from the state of the art in numerous design variants. The known heat pump systems for electric vehicles comprise a coolant side for the circulation of a coolant and a refrigerant side for the circulation of a refrigerant, which is fluidically separated from the coolant side, wherein the coolant side and the refrigerant side are in a heat transfer connection, and wherein the coolant side has a first flow section for the coolant with a first heat exchanger, a second flow section for the coolant with a second heat exchanger, a bypass flow section for the coolant arranged in parallel with the second flow section for the flow-technical bypass of the second heat exchanger, a third flow section for the coolant with a third heat exchanger, a fourth flow section for the coolant, a coolant pump system K and a valve system V for the coolant-side distribution of the coolant.

This is where the present invention comes in.

### SUMMARY OF THE INVENTION

It is therefore an object of the present invention to improve a heat pump system for an electrically operated vehicle.

This object is achieved, in an example, by a heat pump system for an electrically operated vehicle, which is characterized in that the heat pump system is designed in such a way that in a first operating state of the heat pump system W a coolant flow flows through the first flow section with the first heat exchanger, then through the bypass flow section and/or through the second flow section with the second heat exchanger, and then through the fourth flow section, and that in a second operating state of the heat pump system, a coolant flow flows through the first flow section with the first heat exchanger, then through the bypass flow section and/or through the second flow section with the second heat exchanger, and then through the third flow section with the third heat exchanger. The subclaims relate to advantageous further developments of the invention.

A major advantage of the invention lies in particular in the fact that a heat pump system for an electrically operated vehicle is improved. Due to the design of the heat pump system W according to the invention, it is possible to significantly improve the efficiency of the heat pump system W and thus of the thermal management system of an electrically operated vehicle equipped with it in a simple way in terms of circuit technology. This is because by means of the heat pump system according to the invention, a very flexible heat-transferring coupling between heat sources of the heat pump system W and heat sinks of the heat pump system can be realized. Accordingly, even complex thermal management tasks for electrically operated vehicles can be solved much more easily and therefore more cost-effectively.

In principle, the heat pump system according to the invention can be freely selected according to type, function, components, material and dimensioning within wide suitable limits. For example, the heat pump system W for an electrically operated vehicle according to the invention can be used advantageously both for pure electric vehicles and for so-called hybrid vehicles, i.e., vehicles that have a combustion engine and at the same time an electric motor to drive the vehicle. This refers in particular to land vehicles, such as road vehicles or the like. However, the invention can also be used for other types of vehicles.

In a third operating state of the heat pump system, a coolant flow can flow through the first flow section with the first heat exchanger, then through the bypass flow section and/or through the second flow section with the second heat exchanger and then on one side through the third flow section with the third heat exchanger and on the other side through the fourth flow section. In this way, the above-mentioned advantages of the invention are further enhanced.

The first heat exchanger can be a chiller for the transfer of heat from the coolant to the refrigerant. The chiller enables heat transfer between the coolant system on one side and the refrigerant system on the other. Of outstanding importance is the possibility of combining a wide variety of heat sources to operate the heat pump. For this purpose, it is necessary to conduct the corresponding heat flows through the chiller.

The second heat exchanger can be designed in such a way that air can be cooled by means of the second heat exchanger and the coolant flowing therein, preferably that the vehicle cabin air can be cooled in a vehicle cabin of the vehicle by means of the second heat exchanger. This makes it possible to cool air in the vehicle.

The third heat exchanger can be designed in such a way that a heat exchange between the ambient air of a free environment and the coolant is enabled by means of the third heat exchanger, preferably that the third heat exchanger is designed as a front radiator of the vehicle. This also enables heat transfer between the vehicle on the one hand and the free environment on the other.

The valve system can have a valve unit, wherein the valve unit can be fluidically directly connected to the bypass flow section, directly to the second flow section, directly to the third flow section and directly to the fourth flow section, preferably that the valve unit is designed as a 4-way valve. This results in a very flexible design of the heat pump system according to the invention, enabling a plurality of flow states desired in the heat pump system according to the invention. Furthermore, this can be achieved in a very simple way by means of the example of this further development in terms of design, production technology and circuit technology. The wording “directly” is synonymous with “immediately” here and in the following. Accordingly, this wording points out here and in the following that the components mentioned in each case, for example the valve unit and the bypass flow section, are in this case connected to each other in terms of flow technology without the fluidic interposition of another component.

The valve system V additionally can have a second valve unit and a third valve unit, preferably that the second valve unit V2 is designed as a 6-way valve and/or that the third valve unit is designed as a 4-way valve. In this way, the above-mentioned flexibility for the realization of desired switching states is additionally increased in the operation of the heat pump system W according to the invention. By means of the example of this further development, a very simple type of implementation is indicated in terms of design, production technology and circuitry.

As already stated above, the heat pump system according to the invention can be freely selected within wide suitable limits. It is appropriate for the coolant system to include at least one additional component, namely: an electric motor and power electronics for the electric motor to drive the vehicle and/or a vehicle battery of the vehicle to supply electrical energy to the electric motor and the power electronics and/or an interior radiator for heating the vehicle cabin air of a vehicle cabin of the vehicle and/or a liquid-cooled condenser for cooling the refrigerant and/or a coolant tank for storing the coolant, wherein, depending on the switching state of the valve system, the first heat exchanger and/or the second heat exchanger and/or the third heat exchanger can be fluidically connected to at least one of the aforementioned components of the coolant system. The above-mentioned components are each very important components of a heat pump system, so that the heat pump system W according to the invention can be adapted to each individual case of application of the invention by means of a sensible and suitable circuit combination of the components mentioned here.

The valve unit can be fluidically directly connected to the second valve unit by means of the fourth flow section; and/or that the second valve unit is fluidically directly connected to the vehicle battery, preferably that the vehicle battery is fluidically directly connected merely to the second valve unit; and/or that the second valve unit is fluidically directly connected to the drive train and/or directly to the liquid-cooled condenser and/or directly to the coolant radiator and/or directly to the third valve unit, except for a pump of the coolant pump system K located between the second valve unit and the drive train; and/or that the third valve unit is fluidically directly connected to the air heater and/or the liquid-cooled condenser and/or directly to the drive train and/or directly to the third heat exchanger and/or directly to the second valve unit; and/or that the coolant pump system has a pump, a second pump and a third pump, preferably that the pump is fluidically directly connected to the second valve unit and/or directly to the drive train, and/or that the second pump is fluidically directly connected to the liquid-cooled condenser and/or to the air heater and/or directly to the drive train and/or directly to the pump, and/or that the third pump is fluidically directly connected to the second valve unit and/or directly to the third valve unit and/or directly to the first heat exchanger and/or directly to the third heat exchanger.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1a is an example of a heat pump system according to the invention on the basis of a process diagram, with the heat pump system in a first variant of a first operating state,

FIG. 1b shows the example in analogous representation to FIG. 1a in a second variant of the first operating state,

FIG. 1c shows the example in analogous representation to FIG. 1a in a third variant of the first operating state,

FIG. 2a shows the example in analogous representation to FIG. 1a in a first variant of a second operating state,

FIG. 2b shows the example in analogous representation to FIG. 1a in a second variant of the second operating state,

FIG. 3a shows the example in analogous representation to FIG. 1a in a first variant of a third operating state, and

FIG. 3b shows the example in analogous representation to FIG. 1a in a second variant of the third operating state.

### DETAILED DESCRIPTION

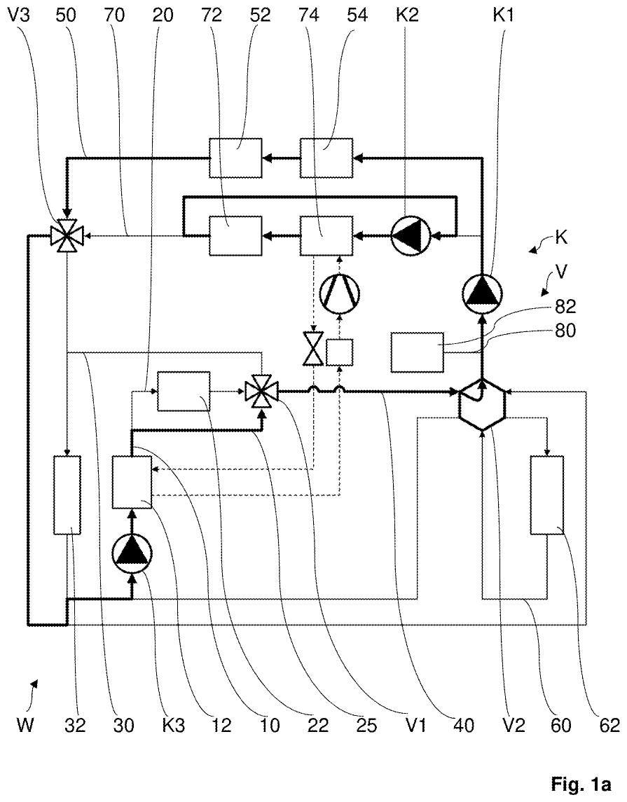

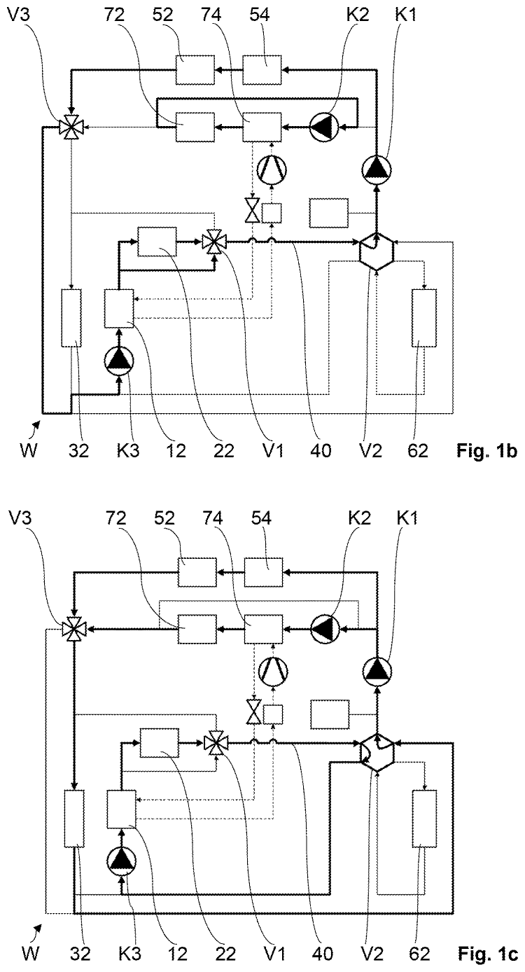

FIGS. 1a to 3b show an example of the heat pump system W according to the invention purely by way of example.

The heat pump system W for an electrically operated vehicle, i.e., an unspecified purely electrically operated car, comprises a coolant side for the circulation of an unshown coolant and a refrigerant side for the circulation of an unshown refrigerant, which is fluidically separated from the coolant side, wherein the coolant side and the refrigerant side are in a heat transfer connection, and wherein the coolant side has a first flow section 10 for the coolant with a first heat exchanger 12, a second flow section 20 for the coolant with a second heat exchanger 22, a bypass flow section 25 for the coolant, arranged in parallel with the second flow section 20 so as to bypass the second heat exchanger 22 in terms of fluid dynamics, a third flow section 30 for the coolant with a third heat exchanger 32, a fourth flow section 40 for the coolant, a coolant pump system K and a valve system V for the coolant-side distribution of the coolant.

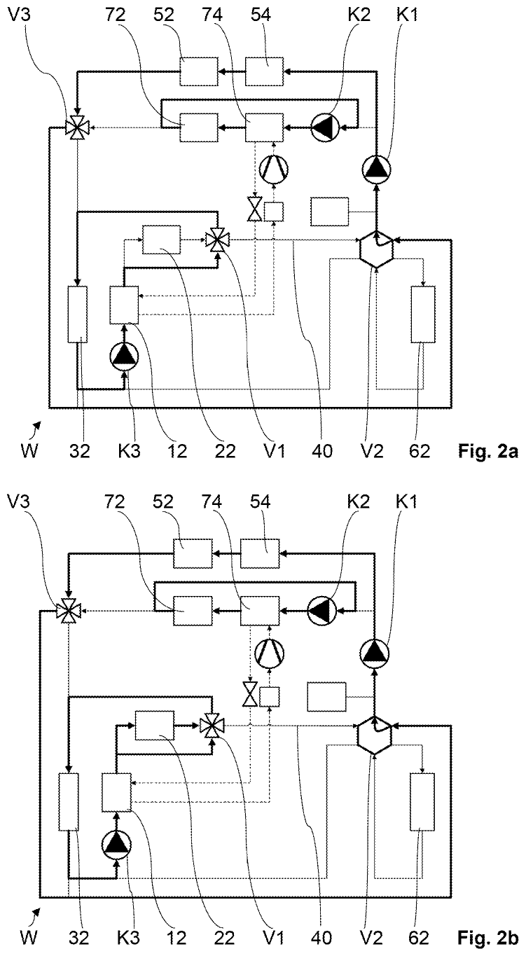

According to the invention, the heat pump system W is designed in such a way that in a first operating state of the heat pump system W, which is shown in three variants in FIGS. 1a to 1c, a coolant flow flows through the first flow section 10 with the first heat exchanger 12, then through the bypass flow section 25 and/or through the second flow section 20 with the second heat exchanger 22 and thereafter through the fourth flow section 40, and that in a second operating state of the heat pump system W, shown in two variants in FIGS. 2a and 2b, a coolant flow flows through the first flow section 10 with the first heat exchanger 12, then through the bypass flow section 25 and/or through the second flow section 20 with the second heat exchanger 22 and then through the third flow section 30 with the third heat exchanger 32.

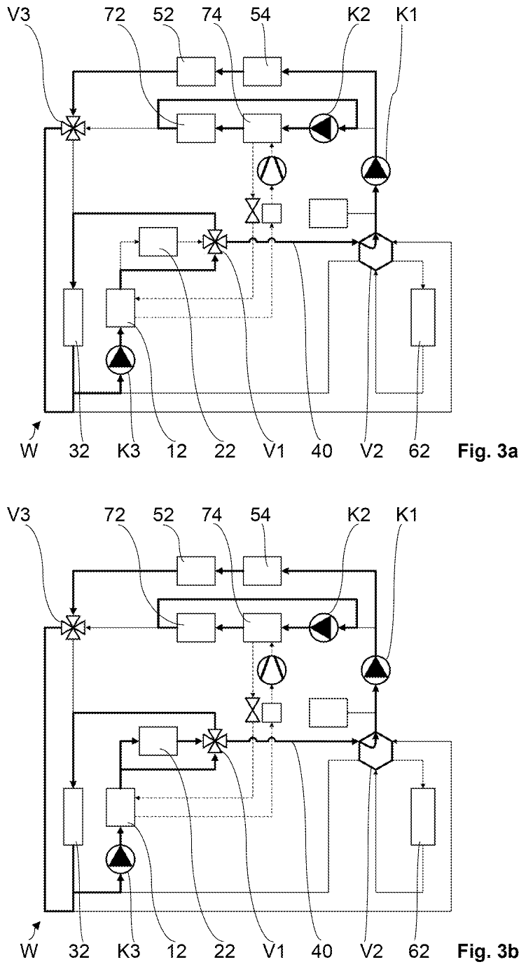

Furthermore, the heat pump system W is designed in such a way that in a third operating state of the heat pump system W, shown in two variants in FIGS. 3a and 3b, a coolant flow flows through the first flow section 10 with the first heat exchanger 12, then through the bypass flow section 25 and/or through the second flow section 20 with the second heat exchanger 22 and then on the one side through the third flow section 30 with the third heat exchanger 32 and on the other through the fourth flow section 40.

In other examples of the invention, a third variant is also possible with regard to the second and third operating states, analogous to the first operating state of the present example. In this case, the coolant flow could therefore only be conducted through the second flow section with the second heat exchanger.

In the present example, the individual components of the heat pump system W are designed as follows:

The first heat exchanger 12 is designed as a chiller for transferring heat from the coolant to the refrigerant. The second heat exchanger 22 is designed in such a way that air (not shown) can be cooled by means of the second heat exchanger 22 and the coolant flowing in it, wherein by means of the second heat exchanger 22, vehicle cabin air can be cooled in a vehicle cabin of the vehicle, not shown. The third heat exchanger 32 is also designed in such a way that the third heat exchanger 32 enables heat exchange between an unshown ambient air of a free environment and the coolant, wherein the third heat exchanger 32 is designed here as a front radiator of the vehicle. The valve system V has a valve unit V1 designed as a 4-way valve, wherein the valve unit V1 is fluidically directly connected to the bypass flow section 25, directly to the second flow section 20, directly to the third flow section 30 and directly to the fourth flow section 40. In addition, the valve system V also has a valve unit V2 designed as a 6-way valve and a valve unit V3 designed as a 4-way valve. In the present example, the coolant pump system K comprises a pump K1, a pump K2 and a pump K3. See, for example, FIG. 1a.

In addition, the heat pump system w also includes the following components:

A drive train 50 with an electric motor 52 and power electronics 54 for the electric motor 52 for the drive of the vehicle and a battery string 60 with a vehicle battery 62 of the vehicle for supplying electrical energy to the electric motor 52 and the power electronics 54 and a coolant line, line 70 for short, arranged in parallel with the drive train 50 in terms of flow with an interior radiator 72 for heating the vehicle cabin air of the vehicle cabin of the vehicle and a liquid-cooled condenser 74 for cooling the refrigerant and a coolant line, line 80 for short, with a coolant tank 82 for storing the coolant, wherein, depending on the switching state of the valve system V, the first heat exchanger 12 and/or the second heat exchanger 22 and/or the third heat exchanger 32 can be fluidically connected to at least one of the aforementioned components of the coolant system. See FIG. 1a to FIG. 3b for a synopsis.

For this purpose, the valve unit V1 is fluidically directly connected to the valve unit V2 by means of the fourth flow section 40. Furthermore, the valve unit V2 is fluidically directly connected to the vehicle battery 62, wherein the vehicle battery 62 in the present example is only fluidically directly connected to the valve unit V2. In addition, the valve unit V2 is fluidically directly connected to the drive train 50 and directly to the liquid-cooled condenser 74, which is then followed by the interior radiator 72 in terms of flow, and directly to the valve unit V3, with the exception of a pump K1 of the coolant pump system K located between the valve unit V2 and the drive train 50. In the present example, this direct connection with the third valve unit V3 is established by means of a bypass line to the interior radiator 72 and the liquid-cooled condenser 74. In addition, the valve unit V3 is fluidically directly connected to the interior radiator 72, which is downstream of the liquid-cooled condenser 74 in the direction of flow, and directly to the drive train 50 and directly to the third heat exchanger 32 and directly to the valve unit V2. The pump K1 is fluidically directly connected to the valve unit V2 and directly to the drive train 50; the pump K2 is fluidically connected directly to the liquid-cooled condenser 74, which is upstream of the interior radiator 72, and directly to the drive train 50 and directly to the pump K1; and the pump K3 is fluidically directly connected to the valve unit V2 and directly to the valve unit V3 and directly to the first heat exchanger 12 and directly to the third heat exchanger 32. Furthermore, in the present example, the heat pump system W has a bypass line to the third heat exchanger 32, which is also fluidically connected to the valve V3.

In the following, the functioning of the heat pump system W according to the invention is explained in more detail according to the present example on the basis of FIGS. 1a to 3b.

The heat pump system W enables a wide range of operating states. Several of these states are explained below by way of example. However, this list is not exhaustive. Accordingly, other sensible and suitable operating conditions, with or without variants, are also conceivable. Coolant lines with flow are indicated by thick solid lines. Otherwise, the coolant lines are shown with thin solid lines. The refrigerant system, shown in FIGS. 1a to 3b with dotted lines, is active in every state, i.e., heat is extracted from the coolant in the chiller 12 and in return the corresponding heat is released back to the coolant via the liquid-cooled condenser 74, LCC for short.

Of outstanding importance here is the combination of a wide variety of heat sources to operate the heat pump system W. For this purpose, the corresponding heat flows must be conducted through the chiller 12.

In the first variant of the first operating state, the vehicle battery 62, or battery for short, is thermally separated from the heat pump system W. The chiller 12 is connected to the drive train 50 and supplies subcooled coolant to it, so that the drive train 50 releases heat to the coolant. The corresponding heat is then transferred from the chiller 12 to the refrigerant system of the heat pump system W. The LCC 74 transfers heat to the line 70, so that heat is stored in it or transferred to the vehicle cabin via the interior radiator 72. The interior radiator 22 is not flowed through. See FIG. 1a.

In the second variant of the first operating state, the battery 62 is thermally separated from the heat pump system W. The chiller 12 is connected to the drive train 50 and supplies subcooled coolant to it, so that the drive train 50 releases heat to the coolant. The corresponding heat is then transferred from the chiller 50 to the refrigerant system of the heat pump system W. The LCC 74 transfers heat to the line 70, so that heat is stored in it or transferred to the vehicle cabin via the interior radiator 72. The second heat exchanger 22, which is also designed as an interior radiator, is cooled by the chiller 12. The distribution of the coolant flow between the bypass flow section 25 and the second flow section 20 is carried out via the valve unit V1. See FIG. 1b.

In the third variant of the first operating state, the drive train 50 is connected to the front radiator 32 in series so that the waste heat from the drive train 50 can be transferred to the free environment. The battery 62 is thermally separated from the heat pump system W. The heat exchanger 22, which is also designed as an interior radiator, is cooled by the chiller 12. The LCC 74 transfers heat to the line 70, so that heat is stored in it or transferred to the vehicle cabin via the interior radiator 72. In addition, part of the heat, namely the excess heat, is also supplied proportionally to the front radiator 32 from the line 70 via the valve unit V3. The bypass flow section 25 is not flowed through. See FIG. 1c.

In the first and second variants of the second operating state of the heat pump system W, the battery 62 is thermally separated from the heat pump system W. The drive train 50 is connected to itself via the valve unit V2, V3 and is heated by its own waste heat. The chiller 12 is connected to the front radiator 32 and supplies subcooled coolant to it, so that the ambient air flowing through the front radiator 32 releases heat to the coolant. The corresponding heat is then transferred from the chiller 12 to the refrigerant system of the heat pump system W. The LCC 74 transfers heat to the line 70, so that heat is stored in it or transferred to the vehicle cabin via the interior radiator 72. The interior radiator 22 is cooled by the chiller 12 as required. The distribution of the coolant flow between the bypass flow section 25 and the second flow section 20 is carried out via the valve unit V1. See FIGS. 2a—here only the bypass flow section 25 is flowed through—and 2b.

In a first variant of the third operating state of the heat pump system W, the battery 62 is thermally separated from the heat pump system W. The chiller 12 is connected to the drive train 50 and supplies subcooled coolant to it, so that the drive train 50 releases heat to the coolant. The corresponding heat is then transferred from the chiller 12 to the refrigerant system of the heat pump system W. The chiller 12 is also connected to the front radiator 32 and supplies subcooled coolant to it, so that the ambient air flowing through the front radiator 32 releases heat to the coolant. The corresponding heat is then transferred from the chiller 12 to the refrigerant system of the heat pump system W. The distribution of the coolant flow is carried out by the ratio of the pumping capacities of the pump K1, K3. The LCC 74 transfers heat to the line 70, so that heat is stored in it or transferred to the vehicle cabin via the interior radiator 72. The interior radiator 22 is not flowed through. See FIG. 3a.

In a second variant of the third operating state of the heat pump system W, the battery 62 is thermally separated from the heat pump system W. The chiller 12 is connected to the drive train 50 and supplies subcooled coolant to it, so that the drive train 50 releases heat to the coolant. The corresponding heat is then transferred from the chiller 12 to the refrigerant system of the heat pump system W. The chiller 12 is also connected to the front radiator 32 and supplies subcooled coolant to it, so that the ambient air flowing through the front radiator 32 releases heat to the coolant. The corresponding heat is then transferred from the chiller 12 to the refrigerant system of the heat pump system W. The distribution of the coolant flow is carried out by the ratio of the pumping capacities of the pump K1, K3. The LCC 72 transfers heat to the line 70, so that heat is stored in it or transferred to the vehicle cabin via the interior radiator 72. The interior radiator 22 is cooled by the chiller 12. The distribution of the coolant flow between the bypass flow section 25 and the second flow section 20 is carried out via the valve unit V1. See FIG. 3b.

In addition to the above-mentioned operating states, in the individual variants, other operating states can be implemented using the heat pump system W, for example. These operating states are not explicitly shown in the drawing. See the following examples:

In a first variant of a fourth operating state, the drive train 50 is cooled via the front radiator 32. The valve unit V3 directs the heated coolant flow from the drive train 50 to the front radiator 32. After the front radiator 32, the coolant is returned to the drive train 50 via the valve unit V2. The LCC 74 is cooled by the front radiator 32. The valve unit V3 directs the heated coolant flow from the LCC 74 to the front radiator 32. After the front radiator 32, the coolant is returned via the valve unit V2. The line 70 to the valve unit V3, which is separate from the drive train 50, enables the LCC 74 and the drive train 50 to be arranged in parallel with respect to the front radiator 32, so that both components can be cooled with the cool coolant from the front radiator 32. This improves the system efficiency of the heat pump system W as compared to a serial arrangement in which the LCC 74 has to be cooled with the warm coolant from the drive train 50. The valve unit V3 allows for the coolant flow to be distributed proportionally between the drive train 50 and the LCC 74. This allows for the cooling for the refrigerant system, namely the LCC 74, to be adjusted as needed. The battery 62 is cooled by the chiller 12. The interior radiator 22 is cooled by the chiller 12. The distribution of the coolant flow between the second flow section 20 through the second interior radiator 22 and the bypass flow section 25, which serves to bypass the interior radiator 22, is carried out via the valve unit V1.

In a second variant of the fourth operating state of the heat pump system W, the drive train 50 is cooled via the front radiator 32. The valve unit V3 directs the heated coolant flow from the drive train 50 to the front radiator 32. After the front radiator 32, the coolant is returned to the drive train 50 via the valve unit V2. The LCC 74 transfers heat to the line 70, so that heat is stored in it or transferred to the vehicle cabin via the interior radiator 72. The battery 62 is cooled by the chiller 12. The interior radiator 22 is cooled by the chiller 12. The distribution of the coolant flow between the bypass flow section 25 and the second flow section 20 is carried out via the valve unit V1.

In a first variant of a fifth operating state of the heat pump system W, the battery 62 is thermally separated from the heat pump system W. The chiller 12 is connected to the drive train 50 and supplies subcooled coolant to it, so that the drive train 50 releases heat to the coolant. The corresponding heat is then transferred from the chiller 12 to the refrigerant system of the heat pump system W. The chiller 12 is also connected to the front radiator 32 and supplies subcooled coolant to it, so that the ambient air flowing through the front radiator 32 releases heat to the coolant. The corresponding heat is then transferred from the chiller 12 to the refrigerant system of the heat pump system W. The distribution of the coolant flow through front radiator 32 and drive train 50 is carried out by the ratio of the pumping capacities of the pump K1, K3. The LCC 74 transfers heat to the line 70, so that heat is stored in it or transferred to the vehicle cabin via the interior radiator 72. In addition, part of the heat from the line 70 is fed proportionally to the chiller 12 via the valve unit V3, so that this heat is transferred back to the refrigerant system. The cooled coolant then flows back into the line 70 via the valve unit V2. This generates additional heat loss in a compressor of the refrigerant system, which is available as additional heating capacity in the line 70. Optionally, the pumps K1, K2 can be controlled in such a way that the volume flow is reduced to a minimum by the drive train 50. This can reduce the influence of the thermal mass of the drive train 50 during a warm-up phase and thus the time required to heat up the line 70. The interior radiator 22 is cooled by the chiller 12. The coolant flow is distributed via the valve unit V1.

In a second variant of the fifth operating state of the heat pump system W, the battery 62 is thermally separated from the heat pump system W. The chiller 12 is connected to the drive train 50 and supplies subcooled coolant to it, so that the drive train 50 releases heat to the coolant. The corresponding heat is then transferred from the chiller 12 to the refrigerant system of the heat pump system W. The chiller 12 is also connected to the front radiator 32 and supplies subcooled coolant to it, so that the ambient air flowing through the front radiator 32 releases heat to the coolant. The corresponding heat is then transferred from the chiller 12 to the refrigerant system of the heat pump system W. The distribution of the coolant flow is carried out by the ratio of the pumping capacities of the pump K1, K3. The LCC 74 transfers heat to the line 70, so that heat is stored in it or transferred to the vehicle cabin via the interior radiator 72. In addition, part of the heat from the line 70 is fed proportionally to the chiller 12 via the valve unit V3, so that this heat is transferred back to the refrigerant system. The cooled coolant then flows back into the line 70 via the valve unit V2. This generates additional waste heat in the compressor, which is available as additional heating power in the line 70. Optionally, the pumps K1, K2 can be controlled in such a way that the volume flow through the drive train 50 is reduced to a minimum. This can reduce the influence of the thermal mass of the drive train 50 during a warm-up phase and thus the time required to heat up the line 70.

In a first variant of a sixth operating state of the heat pump system W, the battery 62 is thermally separated from the heat pump system W. The chiller 12 is connected to the drive train 50 and supplies subcooled coolant to it, so that the drive train 50 releases heat to the coolant. The corresponding heat is then transferred from the chiller 12 to the refrigerant system of the heat pump system W. The LCC 74 transfers heat to the line 70, so that heat is stored in it or transferred to the vehicle cabin via the interior radiator 72. In addition, part of the heat from the line 70 is fed proportionally to the chiller 12 via the valve unit V3, so that this heat is transferred back to the refrigerant system. The cooled coolant then flows back into the line 70 via the valve unit V2. This generates additional waste heat in the compressor, which is available as additional heating power in the line 70. Optionally, the pumps K1, K2 can be controlled in such a way that the volume flow is reduced to a minimum through the drive train 50. This can reduce the influence of the thermal mass of the drive train 50 during a warm-up phase and thus the time required to heat up the line 70. The interior radiator 22 is cooled by the chiller 12. The distribution of the coolant flow between the bypass flow section 25 and the second flow section 20 is carried out via the valve unit V1.

In a second variant of the sixth operating state of the heat pump system W, the battery 62 is thermally separated from the heat pump system W. The chiller 12 is connected to the drive train 50 and supplies subcooled coolant to it, so that the drive train 50 releases heat to the coolant. The corresponding heat is then transferred from the chiller 12 to the refrigerant system of the heat pump system W. The LCC 74 transfers heat to the line 70, so that heat is stored in it or transferred to the vehicle cabin via the interior radiator 72. In addition, part of the heat from the line 70 is fed proportionally to the chiller 12 via the valve unit V3, so that this heat is transferred back to the refrigerant system. The cooled coolant then flows back into the line 70 via the valve unit V2. This generates additional waste heat in the compressor, which is available as additional heating power in the line 70. Optionally, the pumps K1, K2 can be controlled in such a way that the volume flow is reduced to a minimum through the drive train 50. This can reduce the influence of the thermal mass of the drive train 50 during a warm-up phase and thus the time required to heat up the line 70.

In a first variant of a seventh operating state of the heat pump system W, the chiller 12 is connected to the battery 62 and then to the drive train 50 in series and supplies subcooled coolant to them, so that the battery 62 and the drive train 50 transfer heat to the coolant. The corresponding heat is then transferred from the chiller 12 to the refrigerant system of the heat pump system W. By means of the V2 valve unit, it is possible to adjust the proportion of the coolant flow that is routed via the chiller 12 and then via the battery 62 and what proportion bypasses the chiller 12 and goes directly to the battery 62. This allows for the amount of heat sent to the chiller 12 to be controlled as required. The chiller 12 is also connected to the front radiator 32 and supplies subcooled coolant to it, so that the ambient air flowing through the front radiator 32 releases heat to the coolant. The corresponding heat is then transferred from the chiller 12 to the refrigerant system of the heat pump system W. The coolant flow is divided by the ratio of the pumping capacities of the first and third pumps K1, K3. The LCC 74 transfers heat to the line 70, so that heat is stored in it or transferred to the vehicle cabin via the interior radiator 72. In addition, part of the heat from the line 70 is fed proportionally to the chiller 12 via the valve unit V3, so that this heat is transferred back to the refrigerant system. The cooled coolant then flows back to the battery 62 via the valve unit V2. This generates additional waste heat in the compressor, which is available as additional heating power in the line 70. The interior radiator 22 is cooled by the chiller 12. The distribution of the coolant flow between the bypass flow section 25 and the second flow section 20 is carried out via the valve unit V1.

In a second variant of the seventh operating state of the heat pump system W, the chiller 12 is connected to the battery 62 and then to the drive train 50 in series and supplies subcooled coolant to them, so that the battery 62 and the drive train 50 transfer heat to the coolant. The corresponding heat is then transferred from the chiller 12 to the refrigerant system of the heat pump system W. By means of the valve unit V2, it is possible to adjust the proportion of the coolant flow that is routed via the chiller 12 and then to the battery 62 and what proportion bypasses the chiller 12 and goes directly to the battery 62. This allows for the amount of heat sent to the chiller 12 to be controlled as required. The chiller 12 is also connected to the front radiator 32 and supplies subcooled coolant to it, so that the ambient air flowing through the front radiator 32 releases heat to the coolant. The corresponding heat is then transferred from the chiller 12 to the refrigerant system of the heat pump system W. The distribution of the coolant flow is carried out by the ratio of the pumping capacities of the pump K1, K3. The LCC 74 transfers heat to the line 70, so that heat is stored in it or transferred to the vehicle cabin via the interior radiator 72. In addition, part of the heat from the line 70 is fed proportionally to the chiller 12 via the valve unit V3, so that this heat is transferred back to the refrigerant system. The cooled coolant then flows back to the battery 62 via the valve unit V2. This generates additional waste heat in the compressor, which is available as additional heating power in the line 70.

In a third variant of the seventh operating state of the heat pump system W, the chiller 12 is connected to the battery 62 and then to the drive train 50 in series and supplies subcooled coolant to them, so that the battery 62 and the drive train 50 transfer heat to the coolant. The corresponding heat is then transferred from the chiller 12 to the refrigerant system of the heat pump system W. By means of the valve unit V2, it is possible to adjust the proportion of the coolant flow that is routed via the chiller 12 and then to the battery 62 and what proportion bypasses the chiller 12 and goes directly to the battery 62. This allows for the amount of heat sent to the chiller 12 to be controlled as required. The chiller 12 is also connected to the front radiator 32 and supplies subcooled coolant to it, so that the ambient air flowing through the front radiator 32 releases heat to the coolant. The corresponding heat is then transferred from the chiller 12 to the refrigerant system of the heat pump system W. The distribution of the coolant flow is carried out by the ratio of the pumping capacities of the pump K1, K3. The LCC 72 transfers heat to the line 70, so that heat is stored in it or transferred to the vehicle cabin via the interior radiator 72. The interior radiator 22 is cooled by the chiller 12. The distribution of the coolant flow between the bypass flow section 25 and the second flow section 20 is carried out via the valve unit V1.

In a fourth variant of the seventh operating state of the heat pump system W, the chiller 12 is connected to the battery 62 and then to the drive train 50 in series and supplies subcooled coolant to them, so that the battery 62 and the drive train 50 transfer heat to the coolant. The corresponding heat is then transferred from the chiller 12 to the refrigerant system of the heat pump system W. By means of the valve unit V2, it is possible to adjust the proportion of the coolant flow that is routed via the chiller 12 and then to the battery 62 and what proportion bypasses the chiller 12 and goes directly to the battery 62. This allows for the amount of heat sent to the chiller 12 to be controlled as required. The chiller 12 is also connected to the front radiator 32 and supplies subcooled coolant to it, so that the ambient air flowing through the front radiator 32 releases heat to the coolant. The corresponding heat is then transferred from the chiller 12 to the refrigerant system of the heat pump system W. The distribution of the coolant flow is carried out by the ratio of the pumping capacities of the pump K1, K3. The LCC 74 transfers heat to the line 70, so that heat is stored in it or transferred to the vehicle cabin via the interior radiator 72.

In a fifth variant of the seventh operating state of the heat pump system W, the chiller 12 is connected to the battery 62 and then to the drive train 50 in series and supplies subcooled coolant to them, so that the battery 62 and the drive train 50 transfer heat to the coolant. The corresponding heat is then transferred from the chiller 12 to the refrigerant system of the heat pump system W. By means of the valve unit V2, it is possible to adjust the proportion of the coolant flow that is routed via the chiller 12 and then to the battery 62 and what proportion bypasses the chiller 12 and goes directly to the battery 62. This allows for the amount of heat sent to the chiller 12 to be controlled as required. The LCC 74 transfers heat to the line 70, so that heat is stored in it or transferred to the vehicle cabin via the interior radiator 72. The interior radiator 22 is cooled by the chiller 12. The distribution of the coolant flow between the bypass flow section 25 and the second flow section 20 is carried out via the valve unit V1.

In a sixth variant of the seventh operating state of the heat pump system W, the chiller 12 is connected to the battery 62 and then to the drive train 50 in series and supplies subcooled coolant to them, so that the battery 62 and the drive train 50 transfer heat to the coolant. The corresponding heat is then transferred from the chiller 12 to the refrigerant system of the heat pump system W. By means of the valve unit V2, it is possible to adjust the proportion of the coolant flow that is routed via the chiller 12 and then to the battery 62 and what proportion bypasses the chiller 12 and goes directly to the battery 62. This allows for the amount of heat sent to the chiller 12 to be controlled as required. The LCC 74 transfers heat to the line 70, so that heat is stored in it or transferred to the vehicle cabin via the interior radiator 72.

In the above-mentioned variants of the seventh operating state of the heat pump system W, namely variants one to six, a relatively large amount of coolant cooled by the chiller 12 is mixed with warm coolant from the drive train 50 in the valve unit V2, so that in total coolant flows into the battery 62, which is cooler than the battery 62. The battery 62 is therefore the heat source for the coolant here and transfers heat to the coolant.

In the subsequent variants of the seventh operating state of the heat pump system W, namely variants seven to twelve, less coolant cooled by the chiller 12 is mixed with warm coolant from the drive train 50 in the valve unit V2, so that in total coolant flows into the battery 62, which is warmer than the battery 62. The battery 62 is therefore a heat sink for the coolant here and absorbs heat from the coolant.

In a seventh variant of the seventh operating state of the heat pump system W, the battery 62 and the drive train 50 are connected in series, so that the waste heat from the drive train 50 heats the battery 62. By means of the valve unit V2, it is possible to adjust the proportion of the coolant flow that is either routed via the chiller 12 and then to the battery 62 and the proportion that bypasses the chiller 12 and goes directly to the battery 62. This allows for the amount of heat sent to the chiller 12 and to the battery 62 to be controlled as required. The chiller 12 is also connected to the front radiator 32 and supplies subcooled coolant to it, so that the ambient air flowing through the front radiator 32 releases heat to the coolant. The corresponding heat is then transferred from the chiller 12 to the refrigerant system of the heat pump system W. The distribution of the coolant flow is carried out by the ratio of the pumping capacities of the pump K1, K3. The LCC 74 transfers heat to the line 70, so that heat is stored in it or transferred to the vehicle cabin via the interior radiator 72. In addition, part of the heat from the line 70 is fed proportionally to the chiller 12 via the valve unit V3, so that this heat is transferred back to the refrigerant system. The cooled coolant then flows back to the battery 62 via the valve unit V2. This generates additional waste heat in the compressor, which is available as additional heating power in the line 70. The interior radiator 22 is cooled by the chiller 12. The distribution of the coolant flow between the bypass flow section 25 and the second flow section 20 is carried out via the valve unit V1.

In an eighth variant of the seventh operating state of the heat pump system W, the battery 62 and the drive train 50 are connected in series, so that the waste heat from the drive train 50 heats the battery 62. By means of the valve unit V2, it is possible to adjust the proportion of the coolant flow that is selectively routed via the chiller 12 and then to the battery 62 and the proportion that bypasses the chiller 12 and goes directly to the battery 62. This allows for the amount of heat sent to the chiller 12 and to the battery 62 to be controlled as required. The chiller 12 is also connected to the front radiator 32 and supplies subcooled coolant to it, so that the ambient air flowing through the front radiator 32 releases heat to the coolant. The corresponding heat is then transferred from the chiller 12 to the refrigerant system of the heat pump system W. The distribution of the coolant flow is carried out by the ratio of the pumping capacities of the pump K1, K3. The LCC 74 transfers heat to the line 70, so that heat is stored in it or transferred to the vehicle cabin via the interior radiator 72. In addition, part of the heat from the line 70 is fed proportionally to the chiller 12 via the valve unit V3, so that this heat is transferred back to the refrigerant system. The cooled coolant then flows back to the battery 62 via the valve unit V2. This generates additional waste heat in the compressor, which is available as additional heating power in the line 70.

In a ninth variant of the seventh operating state of the heat pump system W, the battery 62 and the drive train 50 are connected in series, so that the waste heat from the drive train 50 heats the battery 62. By means of the valve unit V2, it is possible to adjust the proportion of the coolant flow that is selectively routed via the chiller 12 and then to the battery 62 and the proportion that bypasses the chiller 12 and goes directly to the battery 62. This allows for the amount of heat sent to the chiller 12 and to the battery 62 to be controlled as required. The chiller 12 is also connected to the front radiator 32 and supplies subcooled coolant to it, so that the ambient air flowing through the front radiator 32 releases heat to the coolant. The corresponding heat is then transferred from the chiller 12 to the refrigerant system of the heat pump system W. The distribution of the coolant flow is carried out by the ratio of the pumping capacities of the pump K1, K3. The LCC 74 transfers heat to the line 70, so that heat is stored in it or transferred to the vehicle cabin via the interior radiator 72. The interior radiator 22 is cooled by the chiller 12. The distribution of the coolant flow between the bypass flow section 25 and the second flow section 20 is carried out via the valve unit V1.

In a tenth variant of the seventh operating state of the heat pump system W, the battery 62 and the drive train 50 are connected in series, so that the waste heat from the drive train 50 heats the battery 62. By means of the valve unit V2, it is possible to adjust the proportion of the coolant flow that is either routed via the chiller 12 and then to the battery 62 and the proportion that bypasses the chiller 12 and goes directly to the battery 62. This allows for the amount of heat sent to the chiller 12 and to the battery 62 to be controlled as required. The chiller 12 is also connected to the front radiator 32 and supplies subcooled coolant to it, so that the ambient air flowing through the front radiator 32 releases heat to the coolant. The corresponding heat is then transferred from the chiller 12 to the refrigerant system of the heat pump system W. The distribution of the coolant flow is carried out by the ratio of the pumping capacities of the pump K1, K3. The LCC 74 transfers heat to the line 70, so that heat is stored in it or transferred to the vehicle cabin via the interior radiator 72.

In an eleventh variant of the seventh operating state of the heat pump system W, the battery 62 and the drive train 50 are connected in series, so that the waste heat from the drive train 50 heats the battery 62. By means of the valve unit V2, it is possible to adjust the proportion of the coolant flow that is either routed via the chiller 12 and then to the battery 62 and the proportion that bypasses the chiller 12 and goes directly to the battery 62. This allows for the amount of heat sent to the chiller 12 and to the battery 62 to be controlled as required. The LCC 74 transfers heat to the line 70, so that heat is stored in it or transferred to the vehicle cabin via the interior radiator 72. The interior radiator 22 is cooled by the chiller 12. The distribution of the coolant flow between the bypass flow section 25 and the second flow section 20 is carried out via the valve unit V1.

In a twelfth variant of the seventh operating state of the heat pump system W, the battery 62 and the drive train 50 are connected in series, so that the waste heat from the drive train 50 heats the battery 62. By means of the valve unit V2, it is possible to adjust the proportion of the coolant flow that is either routed via the chiller 12 and then to the battery 62 and the proportion that bypasses the chiller 12 and goes directly to the battery 62. This allows for the amount of heat sent to the chiller 12 and to the battery 62 to be controlled as required. The LCC 74 transfers heat to the line 70, so that heat is stored in it or transferred to the vehicle cabin via the interior radiator 72.

In a first variant of an eighth operating state of the heat pump system W, the battery 62 and the drive train 50 are connected in series, so that the waste heat from the drive train 50 heats the battery 62. The chiller 12 is connected to the front radiator 32 and supplies subcooled coolant to it, so that the ambient air flowing through the front radiator 32 releases heat to the coolant. The corresponding heat is then transferred from the chiller 12 to the refrigerant system of the heat pump system W. The LCC 74 transfers heat to the line 70, so that heat is stored in it or transferred to the vehicle cabin via the interior radiator 72. In addition, part of the heat from the line 70 is supplied proportionally to the battery 62 via the valve unit V3, so that it is heated by heat from the refrigerant system. The interior radiator 22 is cooled by the chiller 12. The distribution of the coolant flow between the bypass flow section 25 and the second flow section 20 is carried out via the valve unit V1.

In a second variant of the eighth operating state of the heat pump system W, the battery 62 and the drive train 50 are connected in series, so that the waste heat from the drive train 50 heats the battery 62. The chiller 12 is connected to the front radiator 32 and supplies subcooled coolant to it, so that the ambient air flowing through the front radiator 32 releases heat to the coolant. The corresponding heat is then transferred from the chiller 12 to the refrigerant system of the heat pump system W. The LCC 74 transfers heat to the line 70, so that heat is stored in it or transferred to the vehicle cabin via the interior radiator 72. In addition, part of the heat from the line 70 is supplied proportionally to the battery 62 via the valve unit V3, so that it is heated by heat from the refrigerant system.

In a third variant of the eighth operating state of the heat pump system W, the battery 62 and the drive train 50 are connected in series, so that the waste heat from the drive train 50 heats the battery 62. The chiller 12 is connected to the front radiator 32 and supplies subcooled coolant to it, so that the ambient air flowing through the front radiator 32 releases heat to the coolant. The corresponding heat is then transferred from the chiller 12 to the refrigerant system of the heat pump system W. The LCC 74 transfers heat to the line 70, so that heat is stored in it or transferred to the vehicle cabin via the interior radiator 72. The interior radiator 22 is cooled by the chiller 12. The distribution of the coolant flow between the bypass flow section 25 and the second flow section 20 is carried out via the valve unit V1.

In a fourth variant of the eighth operating state of the heat pump system W, the battery 62 and the drive train 50 are connected in series, so that the waste heat from the drive train 50 heats the battery 62. The chiller 12 is connected to the front radiator 32 and supplies subcooled coolant to it, so that the ambient air flowing through the front radiator 32 releases heat to the coolant. The corresponding heat is then transferred from the chiller 12 to the refrigerant system of the heat pump system W. The LCC 74 transfers heat to the line 70, so that heat is stored in it or transferred to the vehicle cabin via the interior radiator 72.

In a first variant of a ninth operating state of the heat pump system W, the battery 62 and the drive train 50 are connected in series so that the waste heat from the drive train 50 heats the battery 62. The interior radiator 22 is cooled by the chiller 12. The LCC 74 transfers heat to the line 70, so that heat is stored in it or transferred to the vehicle cabin via the interior radiator 72. In addition, part of the heat from the line 70 of the battery 62 is supplied proportionally via the valve unit V3, so that it is heated by heat from the refrigerant system.

In a second variant of the ninth operating state of the heat pump system W, the battery 62 and the drive train 50 are connected in series, so that the waste heat from the drive train 50 heats the battery 62. The interior radiator 22 is cooled by the chiller 12. The LCC 74 transfers heat to the line 70, so that heat is stored in it or transferred to the vehicle cabin via the interior radiator 72.

In a third variant of the ninth operating state of the heat pump system W, the battery 62 and the drive train 50 are connected to the front radiator 32 in series so that the waste heat from the battery 62 and the drive train 50 can be transferred to the free environment. The interior radiator 22 is cooled by the chiller 12. The LCC 74 transfers heat to the line 70, so that heat is stored in it or transferred to the vehicle cabin via the interior radiator 72. In addition, part of the heat, namely the excess heat, is also supplied proportionally to the front radiator 32 from the line 70 via the valve unit V3.

In a fourth variant of the ninth operating state of the heat pump system W, the battery 62 and the drive train 50 are connected to the front radiator 32 in series so that the waste heat from the battery 62 and the drive train 50 can be transferred to the free environment. The interior radiator 22 is cooled by the chiller 12. The LCC 74 transfers heat to the line 70, so that heat is stored in it or transferred to the vehicle cabin via the interior radiator 72.

In a tenth operating state of the heat pump system W, the drive train is connected to the front radiator 32 in series so that the waste heat from the drive train 50 can be transferred to the free environment. The battery 62 is thermally separated from the heat pump system W. The interior radiator 22 is cooled by the chiller 12. The LCC 74 transfers heat to the line 70, so that heat is stored in it or transferred to the vehicle cabin via the interior radiator 72.

The invention is not limited to the present example. For example, the invention can also be used advantageously in other vehicles. Reference is also made to the relevant explanations in the introduction to the description as well as to the alternatives and options mentioned in the specific examples.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A heat pump system for an electrically operated vehicle, the heat pump system comprising:
a coolant side for a circulation of a coolant; and
a refrigerant side for a circulation of a refrigerant, the refrigerant side being fluidically separated from the coolant side, the coolant side and the refrigerant side being in a heat transfer connection,
wherein the coolant side comprises a first flow section for the coolant with a first heat exchanger, a second flow section for the coolant with a second heat exchanger, a bypass flow section for the coolant arranged in parallel with the second flow section for the flow bypass of the second heat exchanger, a third flow section for the coolant with a third heat exchanger, a fourth flow section for the coolant, a coolant pump system, and a valve system for coolant-side distribution of the coolant,
wherein the heat pump system is designed such that:
in a first operating state of the heat pump system, a coolant flow flows through the first flow section with the first heat exchanger, then through the bypass flow section and/or through the second flow section with the second heat exchanger and then through the fourth flow section, and
in a second operating state of the heat pump system, a coolant flow flows through the first flow section with the first heat exchanger, then through the bypass flow section and/or through the second flow section with the second heat exchanger and then through the third flow section with the third heat exchanger.

2. The heat pump system according to claim 1, wherein, in a third operating state of the heat pump system, a coolant flow flows through the first flow section with the first heat exchanger, then through the bypass flow section and/or through the second flow section with the second heat exchanger and then on one side through the third flow section with the third heat exchanger and on the other side through the fourth flow section.

3. The heat pump system according to claim 1, wherein the first heat exchanger is a chiller for transferring heat from the coolant to the refrigerant.

4. The heat pump system according to claim 1, wherein the second heat exchanger is designed such that air is adapted to be cooled via the second heat exchanger and the coolant flowing therein, or via the second heat exchanger, vehicle cabin air is cooled in a vehicle cabin of the vehicle.

5. The heat pump system according to claim 1, wherein the third heat exchanger is designed such that the third heat exchanger enables heat exchange between ambient air in a free environment and the coolant via the third heat exchanger or wherein the third heat exchanger is designed as a front radiator of the vehicle.

6. The heat pump system according to claim 1, wherein the valve system has a first valve unit fluidically directly connected to the bypass flow section, directly to the second flow section, directly to the third flow section and directly to the fourth flow section, or wherein the first valve unit is designed as a 4-way valve.

7. The heat pump system according to claim 6, wherein the valve system additionally comprises a second valve unit and a third valve unit, wherein the second valve unit is designed as a 6-way valve and/or the third valve unit is designed as a 4-way valve.

8. The heat pump system according to claim 1, wherein the coolant system comprises at least one additional component, namely: an electric motor and power electronics for the electric motor for driving the vehicle and/or a vehicle battery of the vehicle for supplying electrical energy to the electric motor and the power electronics and/or an interior radiator for heating the vehicle cabin air of a vehicle cabin of the vehicle and/or a liquid-cooled condenser for cooling the refrigerant and/or a coolant tank for storing the coolant, and wherein, depending on the switching state of the valve system, the first heat exchanger and/or the second heat exchanger and/or the third heat exchanger are fluidically connected to at least one of the components of the coolant system.

9. The heat pump system according to claim 7, wherein the first valve unit is directly connected to the second valve unit via the fourth flow section.

10. The heat pump system according to claim 8, wherein the second valve unit is fluidically directly connected to the vehicle battery or wherein the vehicle battery is fluidically directly connected to the second valve unit.

11. The heat pump system according to claim 8, wherein the second valve unit is fluidically directly connected to the drive train, except for a pump of the coolant pump system arranged between the second valve unit and the drive train, and/or directly connected to the liquid-cooled condenser, except for a pump of the coolant pump system is arranged between the second valve unit and the condenser, and/or connected to the interior radiator and/or directly to the third valve unit.

12. The heat pump system according to claim 8, wherein the third valve unit is fluidically directly connected to the interior radiator and/or the liquid-cooled condenser and/or directly to the drive train and/or directly to the third heat exchanger and/or directly to the second valve unit.

13. The heat pump system according to claim 8, wherein the coolant pump system comprises a first pump, a second pump, and a third pump, or wherein the first pump is fluidically directly connected to the second valve unit and/or directly to the drive train, and/or wherein the second pump is fluidically directly connected to the liquid-cooled condenser and/or to the interior radiator and/or directly to the drive train and/or directly to the first pump, and/or wherein the third pump is fluidically directly connected to the second valve unit and/or directly to the third valve unit and/or directly to the first heat exchanger and/or directly to the third heat exchanger.
